(19) United States
(12) Patent Application Publication
(10) Pub. No.: US 2026/0196769 A1
(43) Pub. Date: Jul. 9, 2026

(54) CABLE ASSEMBLY

(71) Applicant: BIZLINK INTERNATIONAL CORP., New Taipei City (TW)

(72) Inventors: Guang Zong HU, New Taipei City (TW); Yi-Hsing CHUNG, New Taipei City (TW)

(21) Appl. No.: 19/012,902

(22) Filed: Jan. 8, 2025

(51) Int. Cl. H01R 13/627; H01R 12/72; H01R 12/53

(52) U.S. Cl. CPC H01R 13/6275; H01R 12/721; H01R 12/53

(57) ABSTRACT

A cable assembly includes a connector, a PCB, a latch and some cables. The connector includes a body, an upper cantilever, an intermediate cantilever and a locking part. The body has a front surface and a bottom surface. The upper and the intermediate cantilevers respectively extend forward from the front surface. The locking part is secured with the intermediate cantilever. The locking part has some protrusions extending in a direction opposite to the upper cantilever and away from the intermediate cantilever. The PCB extends forward from the front surface and locates between the upper and the intermediate cantilevers. The latch is mounted on a side of the upper cantilever facing away from the PCB. The cables electrically connect with the PCB in the main body and extend away from the bottom surface of the main body.

### BACKGROUND

### TECHNICAL FIELD

The present disclosure relates to a cable assembly, in detail, a high speed cable assembly for data transmission.

### DESCRIPTION OF RELATED ART

In the Chinese patent 115764433A, a cable end connector and board end connector are disclosed. The cable end connector is configured to be connected with the board end connector. However, after the cable end connector is connected with the board end connector, the cable end connector is not disposed with any locking part to snap with the board end connector for preventing the cable end connector from being tilted relative to and thus displaced or even detached from the board end connector in case a sideward force is applied to the cable end connector. In other words, when a sideward force is applied to the cable end connector after the cable end connector is connected with the board end connector, the cable end connector may tilt relative to the board end connector, such that the cable end connector may be displaced or even detached from the board end connector.

### SUMMARY

The present disclosure pertains to a cable assembly specifically designed to resist displacement or detachment when exposed to lateral forces. The cable assembly, for instance, includes a high-speed server connector (e.g., Genz, MCIO, Multi-trak, etc.), which the said connector has a connector with at least two or three cantilevers which a PCB is disposed between the first and the second cantilevers. In the case the connector has three cantilevers, the cable assembly is characterized by that the second cantilever (or called an intermediate cantilever), positioned between the upper and lower cantilevers, is equipped with a locking part on its surface. Under normal circumstances, when the connector of the cable assembly connects with an external board-end SMT connector, the metal frame of the SMT connector is positioned between the intermediate cantilever and the lower cantilever, and the protrusion of the locking part does not engage with the hole on the frame. However, when a lateral force is applied to the connector, the protrusion enters the hole in the frame from the inside out, thereby securing the metal frame of the corresponding connector. This mechanism effectively prevents detachment when lateral forces are applied.

Moreover, the intermediate cantilever may be configured with a greater thickness than the first and lower cantilevers, thereby enhancing structural strength and mechanical robustness. Additionally, the locking part is integrally formed from a single piece of metal and features a mounting plate along with snapping portions that securely engage with the edges of the intermediate cantilever.

### BRIEF DESCRIPTION OF THE DRAWINGS

The disclosure can be more fully understood by reading the following detailed description of the embodiments, with reference made to the accompanying drawings as follows:

FIG. 1 is a schematic view of a cable assembly according to an embodiment of the present disclosure;

FIG. 2 is a front view of the cable assembly of FIG. 1;

FIG. 3 is a sectional view along the sectional line A-A of FIG. 2;

FIG. 4 is a sectional view along the sectional line B-B of FIG. 2;

FIG. 5 is a schematic view of a cable assembly according to another embodiment of the present disclosure;

FIG. 6 is a schematic view of the cable assembly of FIG. 5 in another visual angle, in which the lower cantilever is omitted;

FIG. 7 is a schematic view of the locking part and the connector of FIGS. 5-6, in which the locking part is detached from the intermediate cantilever; and

FIG. 8 is a sectional view of a cable assembly according to a further embodiment of the present disclosure.

### DETAILED DESCRIPTION

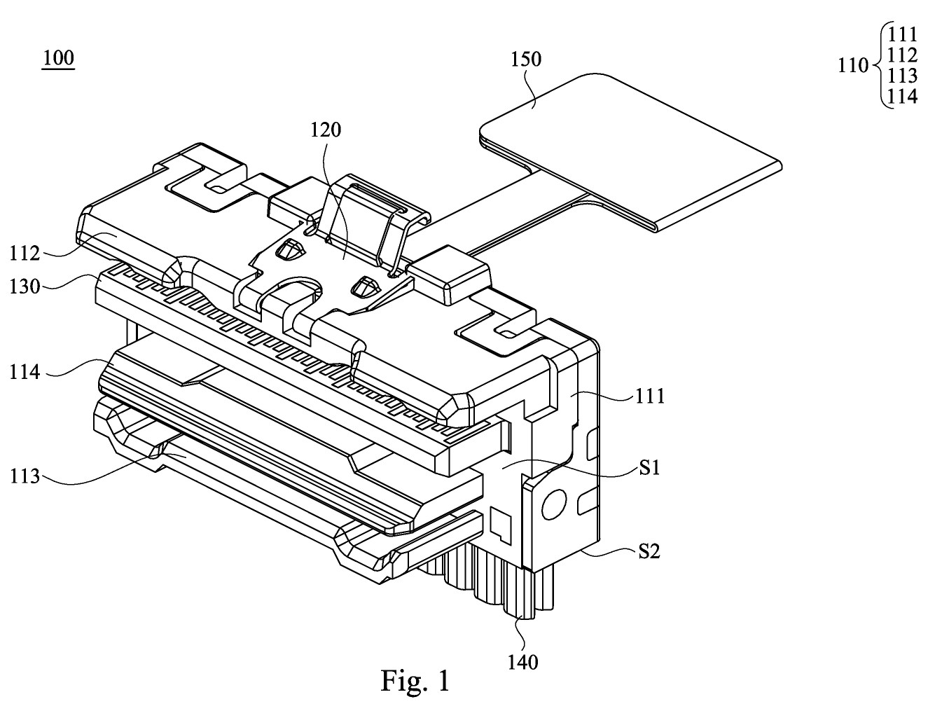

FIGS. 1-8 are drawn according to the actual scale. For the sake of concise description in this specification, the scales of the elements are not listed one by one. However, the scale and position of each element should be regarded as part of the scope of this specification.

Furthermore, if the description in this specification is insufficient to explain the detailed design of the elements and makes it uneasy to implement, please take the electrical connector disclosed in the Chinese patent 115764433A as a reference.

As shown in FIGS. 1-8, a cable assembly 100 is provided in the present disclosure. Moreover, for example, the cable assembly 100 is utilized for electrical connection of high current.

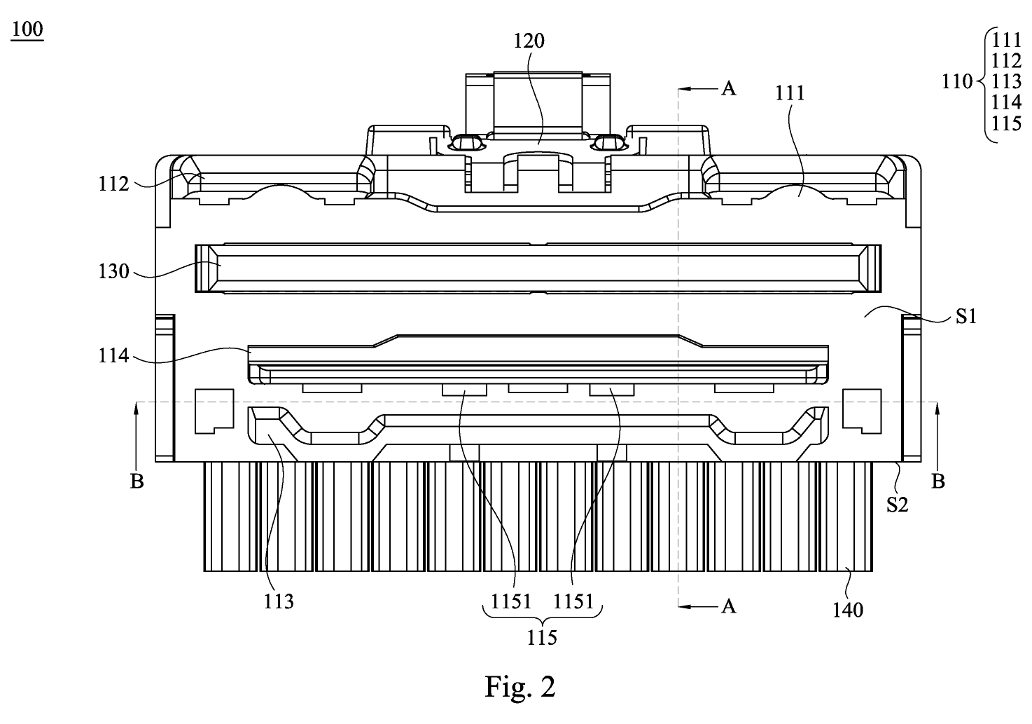

FIG. 1 is a schematic view of a cable assembly 100 according to an embodiment of the present disclosure. FIG. 2 is a front view of the cable assembly 100 of FIG. 1. In this embodiment, as shown in FIGS. 1-2, a cable assembly 100 includes a connector 110, a latch 120, a PCB 130, a plurality of cables 140 and a pull tab 150.

Furthermore, as shown in FIGS. 1-2, the connector 110 includes a main body 111, an upper cantilever 112, a lower cantilever 113, an intermediate cantilever 114 and a locking part 115. The main body 111 has a front surface S1 and a bottom surface S2 different from the front surface S1. In fact, the bottom surface S2 is adjacent to the front surface S1. The upper cantilever 112, the lower cantilever 113 and the intermediate cantilever 114 are respectively extended from the front surface S1 of the main body 111. The intermediate cantilever 114 is located between the upper cantilever 112 and the lower cantilever 113. In this embodiment, the locking part 115 is disposed on a side of the intermediate cantilever 114 facing to the lower cantilever 113. The latch 120 is disposed on a side of the upper cantilever 112 away from the intermediate cantilever 114. The pull tab 150 is connected with the latch 120 and configured to be pulled to elastically deform the latch 120. The PCB 130 is extended from the front surface S1 of the main body 111. The PCB 130 is located between the upper cantilever 112 and the intermediate cantilever 114. The cables 140 are extended from the bottom surface S2 of the main body 111.

To be specific, as shown in FIG. 2, the locking part 115 includes a plurality of protrusions 1151. The protrusions 1151 are respectively disposed on the side of the intermediate cantilever 114 facing to the lower cantilever 113. The protrusions 1151 are spaced apart from each other.

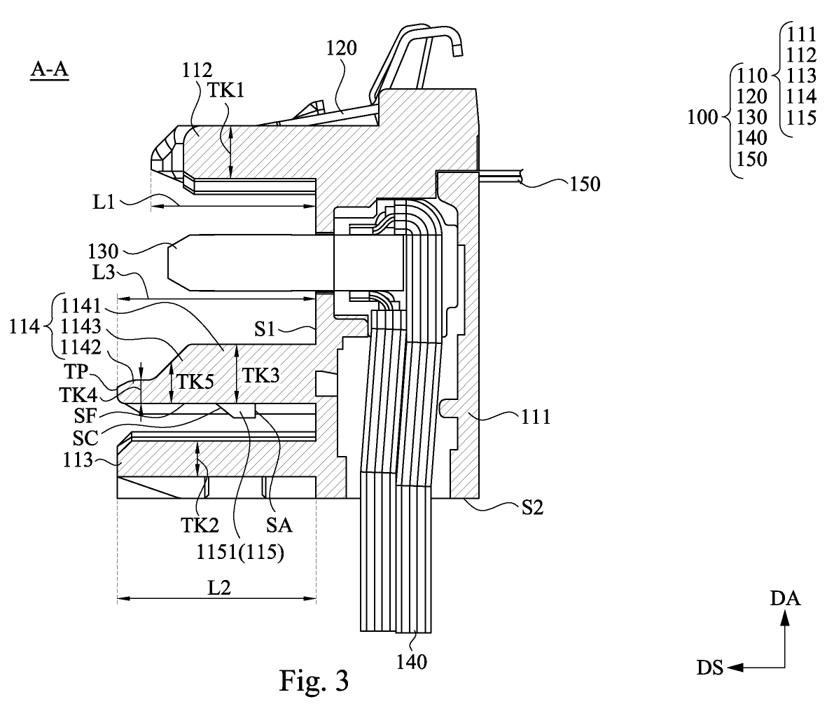

Reference is made to FIG. 3. FIG. 3 is a sectional view along the sectional line A-A of FIG. 2. In this embodiment, as shown in FIG. 3, the protrusion 1151 of the locking part 115 has an abutting surface SA and an inclined surface SC. The inclined surface SC is opposite to the abutting surface SA. The abutting surface SA faces to and is parallel with the front surface S1 of the main body 111. The inclined surface SC is away from and inclined with the front surface S1 of the main body 111. Moreover, the intermediate cantilever 114 has a tip TP away from the front surface S1 of the main body 111. The inclined surface SC of the protrusion is spaced apart from the tip TP of the intermediate cantilever 114.

With the presence of the protrusions 1151, when the cable assembly 100 is connected with another connector (not shown), the protrusions 1151 of the locking part 115 can be snapped into the corresponding holes of this connector in case the cable assembly 100 is tilted relative to this connector due to a sideward force applied on the cable assembly 100. Consequently, the abutting surfaces SA of the protrusions 1151 abut against the inner edges forming these holes, such that the cable assembly 100 is effectively prevented from being displaced or even detached from this connector in case a sideward force is applied on the cable assembly 100.

Moreover, as shown in FIG. 3, the upper cantilever 112, the intermediate cantilever 114 and the lower cantilever 113 are arranged along an arrangement direction DA. The arrangement direction DA is substantially parallel with the front surface S1 of the main body 111. The upper cantilever 112 has a first thickness TK1 along the arrangement direction DA. The lower cantilever 113 has a second thickness TK2 along the arrangement direction DA. The intermediate cantilever 114 has a third thickness TK3 along the arrangement direction DA. It is worth to note that, in this embodiment, the third thickness TK3 of the intermediate cantilever 114 is larger than the first thickness TK1 of the upper cantilever 112 and the second thickness TK2 of the lower cantilever 113.

Since the intermediate cantilever 114 is thicker than the upper cantilever 112 and the lower cantilever 113, the intermediate cantilever 114 is relatively uneasy to be deformed and thus provides a better strength for the protrusions 1151 of the locking part 115 when the abutting surfaces SA of the protrusions 1151 abut against another connector as mentioned above. Hence, the cable assembly 100 is effectively prevented from being detached from this connector in case a sideward force is applied on the cable assembly 100.

Furthermore, as shown in FIG. 3, the intermediate cantilever 114 includes a base section 1141, a front section 1142 and a middle section 1143. The middle section 1143 is connected between the base section 1141 and the front section 1142. The base section 1141 is connected with and extended from the front surface S1 of the main body 111 and defines the third thickness TK3 as mentioned above. The front section 1142 is away from the front surface S1 and has a fourth thickness TK4 along the arrangement direction DA. The fourth thickness TK4 of the front section 1142 is less than the third thickness TK3 of the base section 1141. The middle section 1143 has a fifth thickness TK5 along the arrangement direction DA. The fifth thickness TK5 of the middle section 1143 increases from the front section 1142 towards the base section 1141. In practice, the base section 1141, the front section 1142 and the middle section 1143 together define a common flat surface SF facing towards the lower cantilever 113. The protrusions 1151 of the locking part 115 are disposed on the common flat surface SF.

In addition, as shown in FIG. 3, the upper cantilever 112, the lower cantilever 113 and the intermediate cantilever 114 respectively extend along an insertion direction DS. The insertion direction DS is substantially perpendicular to the front surface S1 of the main body 111. Moreover, the upper cantilever 112 has a first length L1 relative to the front surface S1 along the insertion direction DS. The lower cantilever 113 has a second length L2 relative to the front surface S1 along the insertion direction DS. The intermediate cantilever 114 has a third length L3 relative to the front surface S1 along the insertion direction DS. It is worth to note that, in this embodiment, the first length L1 of the upper cantilever 112 is shorter than the second length L2 of the lower cantilever 113 and the third length L3 of the intermediate cantilever 114. In addition, the second length L2 of the lower cantilever 113 is substantially equal to the third length L3 of the intermediate cantilever 114.

On the other hand, as shown in FIG. 3, the cables 140 are electrically connected with the PCB 130, and the connection structure between the PCB 130 and the cables 140 is located within the main body 111 of the connector 110.

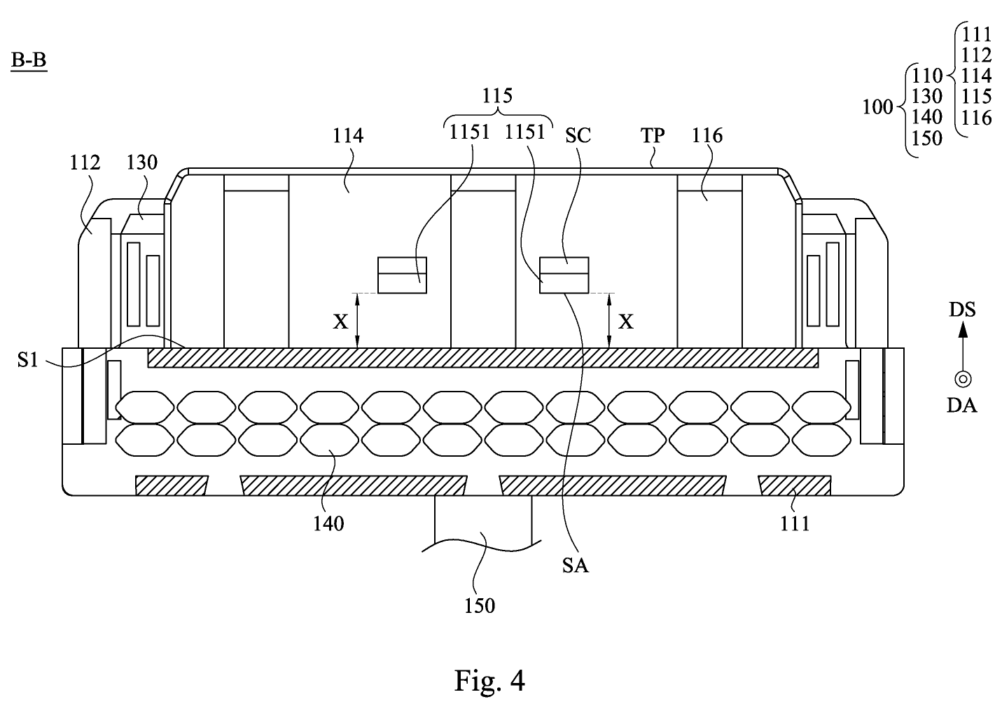

Reference is made to FIG. 4. FIG. 4 is a sectional view along the sectional line B-B of FIG. 2. In this embodiment, as shown in FIG. 4, the connector 110 further includes a plurality of guiding portions 116. The guiding portions 116 are protruded from a side of the intermediate cantilever 114 facing to the lower cantilever 113. Each of the guiding portions 116 extends along the insertion direction DS. In practice, the guiding portions 116 are alternatively arranged with the protrusions 1151 of the locking part 115.

Moreover, as shown in FIG. 4, the abutting surface SA of each of the protrusions 1151 is spaced apart from the front surface S1 of the main body 111 by the same distance X along the insertion direction DS.

In practical applications, the connector 110 is one piece formed. This means the main body 111, the upper cantilever 112, the lower cantilever 113, the intermediate cantilever 114, the protrusions 1151 of the locking part 115 and the guiding portions 116 are integrally formed from a single piece of material.

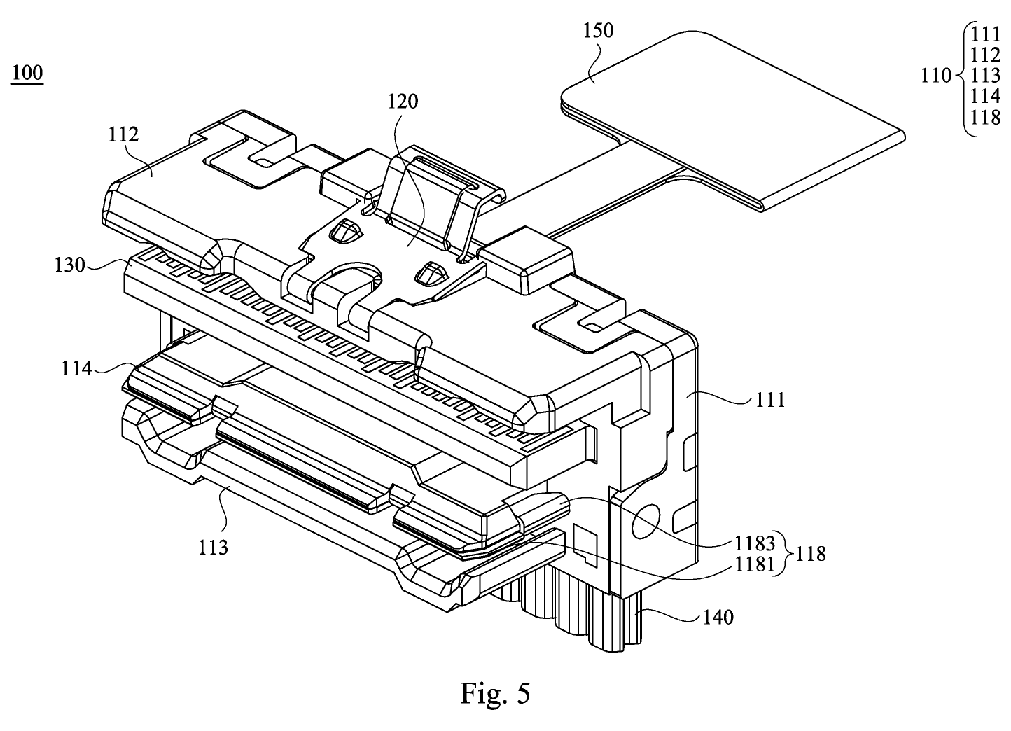

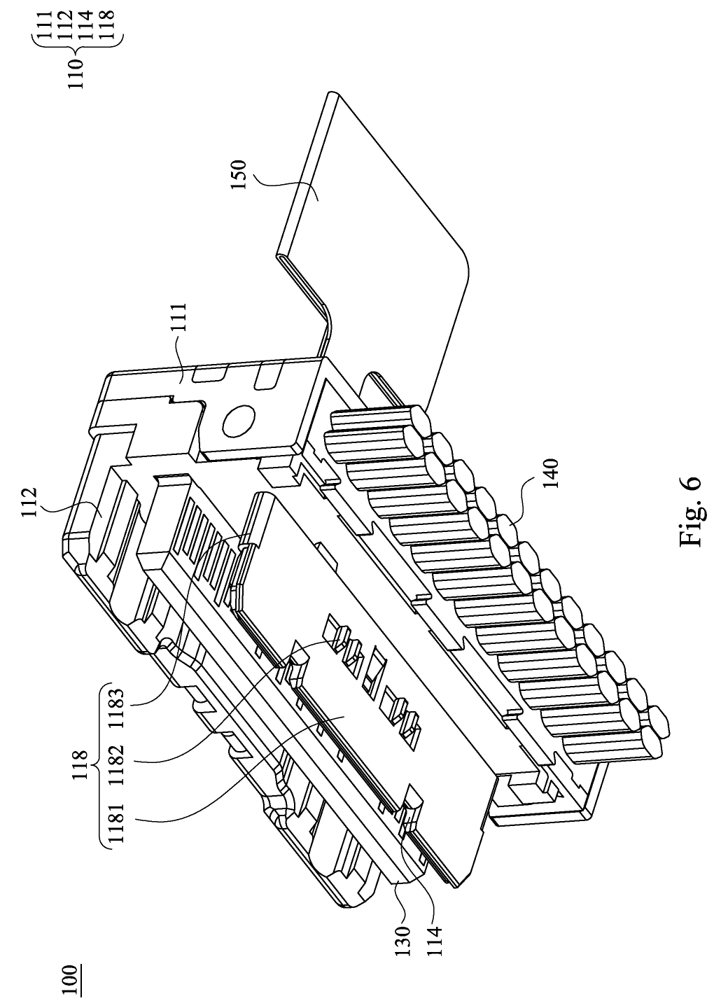

Reference is made to FIGS. 5-6. FIG. 5 is a schematic view of a cable assembly 100 according to another embodiment of the present disclosure. FIG. 6 is a schematic view of the cable assembly 100 of FIG. 5 in another visual angle, in which the lower cantilever 113 is omitted for the sake of drawing clarity. The main difference of this embodiment from the embodiment mentioned above is that: in this embodiment, as shown in FIGS. 5-6, the locking part 118 includes a mounting plate 1181, a plurality of protrusions 1182 and a plurality of snapping portions 1183. The mounting plate 1181, the protrusions 1182 and the snapping portions 1183 are one piece formed metal. This means the mounting plate 1181, the protrusions 1182 and the snapping portions 1183 are integrally formed from a single piece of metal.

Moreover, as shown in FIGS. 5-6, the mounting plate 1181 is disposed on the side of the intermediate cantilever 114 facing to the lower cantilever 113. The protrusions 1182 are respectively disposed on a side of the mounting plate 1181 facing to the lower cantilever 113. In practice, each of the protrusions 1182 is bent from the mounting plate 1181. The snapping portions 1183 are disposed on an edge of the mounting plate 1181.

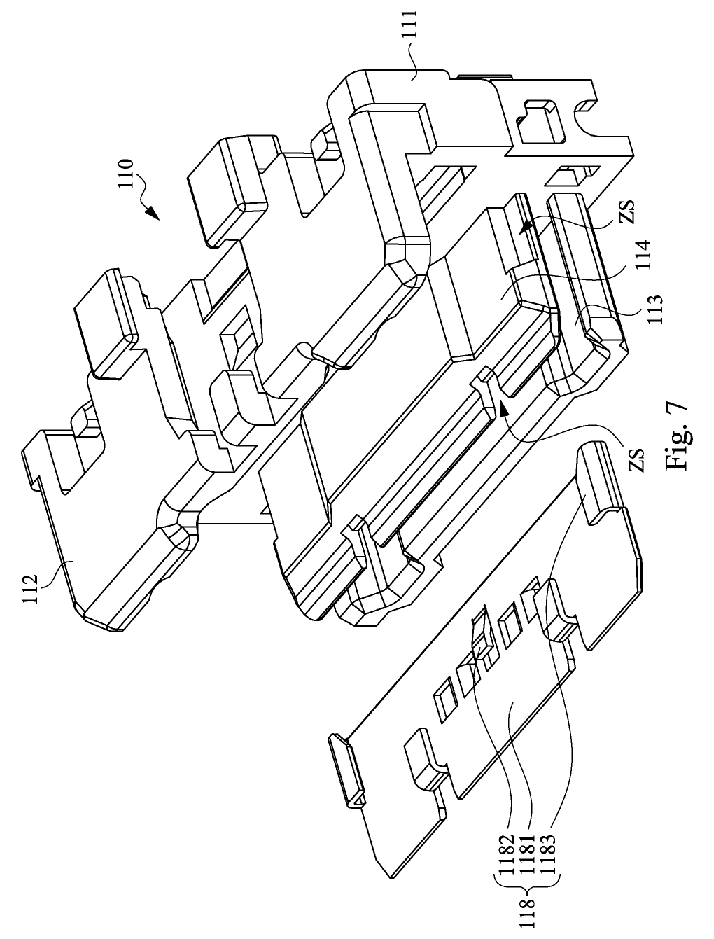

Reference is made to FIG. 7. FIG. 7 is a schematic view of the locking part 118 and the connector 110 of FIGS. 5-6, in which the locking part 118 is detached from the intermediate cantilever 114. In details, as shown in FIG. 7, the intermediate cantilever 114 has a plurality of snapping zones ZS. The snapping zones ZS are distributed at an edge of the intermediate cantilever 114. Meanwhile, the snapping portions 1183 of the locking part 118 are configured to snap with the intermediate cantilever 114 at the snapping zones ZS, such that the locking part 118 is mounted to the intermediate cantilever 114, as shown in FIGS. 5-6.

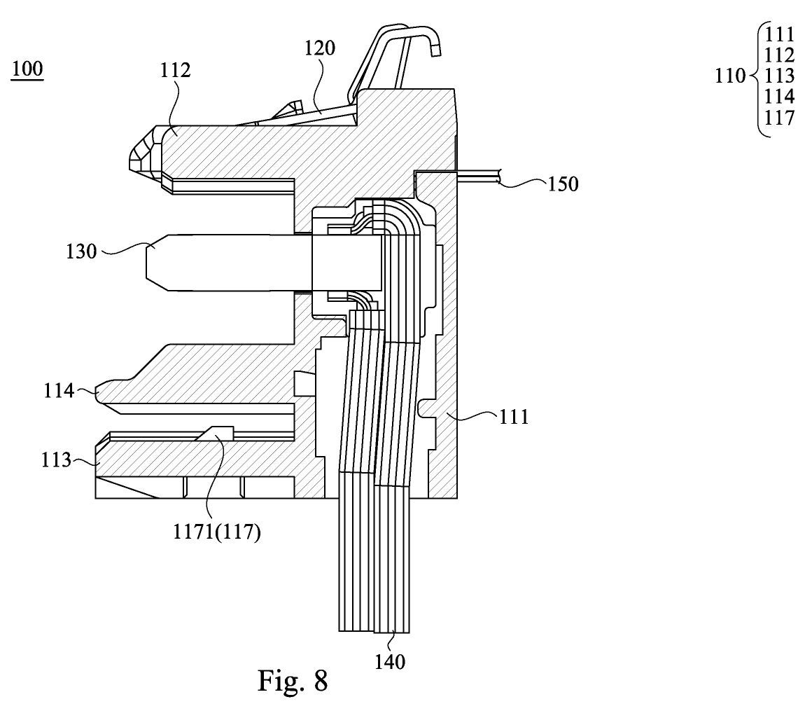

Reference is made to FIG. 8. FIG. 8 is a sectional view of a cable assembly 100 according to a further embodiment of the present disclosure. The main difference of this embodiment from the embodiments mentioned above is that: in this embodiment, as shown in FIG. 8, instead of being disposed on the intermediate cantilever 114, the locking part 117 is disposed on a side of the lower cantilever 113 facing to the intermediate cantilever 114. In other words, the protrusions 1171 of the locking part 117 are respectively disposed on the side of the lower cantilever 113 facing to the intermediate cantilever 114.

In conclusion, the aforementioned embodiments of the present disclosure have at least the following advantages:

(1) With the presence of the protrusions, when the cable assembly is connected with another connector, the protrusions of the locking part can be snapped into the corresponding holes of this connector in case the cable assembly is tilted relative to this connector due to a sideward force applied on the cable assembly. Consequently, the abutting surfaces of the protrusions abut against the inner edges forming these holes, such that the cable assembly is effectively prevented from being displaced or even detached from this connector in case a sideward force is applied on the cable assembly.

(2) Since the intermediate cantilever is thicker than the upper cantilever and the lower cantilever, the intermediate cantilever is relatively uneasy to be deformed and thus provides a better strength for the protrusions of the locking part when the abutting surfaces of the protrusions abut against another connector as mentioned above. Hence, the cable assembly is effectively prevented from being detached from this connector in case a sideward force is applied on the cable assembly.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A cable assembly, comprising:
a connector, comprising:
a main body having a front surface and a bottom surface;
an upper cantilever extending forward from the front surface;
an intermediate cantilever extending forward from the front surface; and
a locking part secured with the intermediate cantilever, the locking part having a plurality of protrusions extending in a direction opposite to the upper cantilever and away from the intermediate cantilever;
a PCB extending forward from the front surface and located between the upper cantilever and the intermediate cantilever;
a latch mounted on a side of the upper cantilever facing away from the PCB; and
a plurality of cables electrically connected with the PCB in the main body and extending away from the bottom surface of the main body.

2. The cable assembly of claim 1, wherein the connector further comprises a lower cantilever extending forward from the front surface, the intermediate cantilever is located between the upper cantilever and the lower cantilever, each of the protrusions of the locking part has an abutting surface and an inclined surface opposite to the abutting surface, the abutting surface faces to the front surface, the inclined surface faces away from and inclined with the front surface.

3. The cable assembly of claim 2, wherein the abutting surface of each of the protrusions is spaced apart from the front surface by a same distance.

4. The cable assembly of claim 2, wherein the intermediate cantilever has a tip away from the front surface, the inclined surface of each of the protrusions is spaced apart from the tip.

5. The cable assembly of claim 2, wherein the intermediate cantilever extends along an insertion direction perpendicular to the front surface, the connector further comprises:
a plurality of guiding portions protruded from a side of the intermediate cantilever facing to the lower cantilever, each of the guiding portions extends along the insertion direction.

6. The cable assembly of claim 5, wherein the guiding portions are alternatively arranged with the protrusions.

7. The cable assembly of claim 5, wherein the main body is one piece formed with the upper cantilever, the intermediate cantilever and the lower cantilever.

8. The cable assembly of claim 2, wherein the upper cantilever, the intermediate cantilever and the lower cantilever are arranged along an arrangement direction, a maximum thickness of the intermediate cantilever along the arrangement direction is larger than a maximum thickness of each of the upper cantilever and the lower cantilever.

9. The cable assembly of claim 8, wherein the intermediate cantilever comprises a base section connecting with the front surface of the main body, a front section and a middle section, the middle section is connected between the base section and the front section, a maximum thickness of the base section defines the maximum thickness of the intermediate cantilever and is larger than a maximum thickness of the middle section, the maximum thickness of the middle section is larger than a maximum thickness of the front section, the maximum thickness of the middle section increases from the front section towards the base section.

10. The cable assembly of claim 9, wherein a central part of the base section of the intermediate cantilever is elevated compared to both lateral sides thereof, a maximum length of the upper cantilever toward the insertion direction is smaller than a maximum length of each of the intermediate cantilever and the lower cantilever, the maximum length of the intermediate cantilever and the maximum length of the lower cantilever are substantially equal.

11. The cable assembly of claim 2, wherein the locking part comprises:
a mounting plate secured with the intermediate cantilever, the protrusions are respectively disposed on a side of the mounting plate facing to the lower cantilever, the mounting plate and the protrusions are one piece formed in a form of a metal plate.

12. The cable assembly of claim 11, wherein the abutting surface of each of the protrusions is spaced apart from the front surface by a same distance.

13. The cable assembly of claim 11, wherein the intermediate cantilever has a tip away from the front surface, the inclined surface of each of the protrusions is spaced apart from the tip.

14. The cable assembly of claim 11, wherein the intermediate cantilever has a plurality of snapping zones distributed at an edge of the intermediate cantilever, the locking part comprises:
a plurality of snapping portions disposed on an edge of the mounting plate and configured to snap with the intermediate cantilever at the snapping zones, the mounting plate, the protrusions and the snapping portions are one piece formed metal.
